(19) United States
(12) Patent Application Publication
(10) Pub. No.: US 2024/0005157 A1
(43) Pub. Date: Jan. 4, 2024

(54) METHODS AND SYSTEMS FOR UNSTRUCTURED PRUNING OF A NEURAL NETWORK

(71) Applicant: LightMetrics Technologies Pvt. Ltd., Bangalore (IN)

(72) Inventors: Krishna A G, Bangalore (IN); Mithun ULIYAR, Bangalore (IN); Ravi SHENOY, Bangalore (IN)

(21) Appl. No.: 17/761,182

(22) PCT Filed: Sep. 15, 2021
(86) PCT No.: PCT/IN2021/050913

§ 371 Date: Mar. 24, 2022

(30) Foreign Application Priority Data
Sep. 17, 2020 (IN) 202041040337

(51) Int. Cl. G06N 3/082

(52) U.S. Cl. CPC G06N 3/082

(57) ABSTRACT

Embodiments provide methods and systems for unstructured pruning of a neural network. Method performed by a neural network pruning system includes accessing a trained neural network to be pruned. The trained neural network includes one or more neural layers. The method includes computing values of layer parameters for a filter associated with a neural layer based, at least in part, on a pruning criteria. The method further includes computing a tag identifier associated with the filter of the trained neural network based, at least in part, on corresponding values of layer parameters of the filter. The method further includes storing the tag identifier and the values of the layer parameters for filter of the trained neural network in a database.

### TECHNICAL FIELD

The present disclosure relates to optimization of neural networks and, more particularly to, methods and processing systems for unstructured pruning of a neural network for inference.

### BACKGROUND

In recent years, deep neural network has revolutionized Artificial Intelligence (AI) and proved to be a critical aspect of machine learning to solve real-time problems across different domains, such as, computer vision, natural language processing, etc. Deep neural networks include multiple layers and computations are performed by these many layers, which are interconnected through different weights. With increasing number of layers and parameters, computational complexity of the deep neural networks increase thereby, resulting in consuming huge memory and computational resources.

Conventionally, users install and store many software applications on their device (e.g., smartphone, tablet) for accessing the software applications when required. If these software applications include deep neural networks, the software applications usually take up a lot of storage space (i.e., memory) that may result in conditions such as slow running time and downtime. This problem arises as the weight matrices of trained neural networks are dense matrices. Additionally, these weight matrices are filled with non-zero elements, thereby consuming extensive storage resources and computation resources, which reduces computational speed and increases costs of the devices in which they are deployed. Moreover, such computationally intensive deep neural networks consume computational resources that may slow down other applications/activities in the device. Thus, there are huge challenges in deploying deep neural networks in mobile devices.

Traditionally, neural networks are pruned to reduce resource requirements (i.e., storage space, computational requirements) by systematically removing parameters from a trained neural network without significantly affecting the accuracy of the trained neural network. In other words, structured pruning of a trained neural network is performed by identifying and removing channels/filters in a neural network (e.g., Convolutional Neural Network) that are not important, thereby resulting in an optimized neural network with accuracy similar to the trained neural network. This allows efficient implementation of the optimized neural network (i.e., pruned neural network) on existing hardware such as Graphic Processing Units (GPUs) as Floating Point Operations per Second (FLOPS) are reduced as filters are reduced. However, there is a limitation on structural pruning of the neural network without significantly affecting the functional performance or accuracy of a neural network.

In view of the above discussion, there exists a need for technical solutions for optimizing neural networks so as to enable wider deployment on mobile devices that cost lesser.

### SUMMARY OF INVENTION

Various embodiments of the present disclosure provide methods and systems for unstructured pruning of a neural network for optimizing the neural networks so as to enable wider deployment on mobile devices and other devices having relatively lower computational ability.

In an embodiment, a computer-implemented method for unstructured pruning of a neural network is disclosed. The computer-implemented method performed by a neural network processing system includes accessing, by a processor, a trained neural network to be pruned. The trained neural network includes one or more neural layers. The computer-implemented method includes computing, by the processor, values of layer parameters for a filter associated with a neural layer of the one or more neural layers based, at least in part, on a pruning criteria. The computer-implemented method also includes computing, by the processor, a tag identifier associated with the filter based, at least in part, on corresponding values of layer parameters of the filter. The computer-implemented method further includes storing, by the processor, the tag identifier and the values of the layer parameters for the filter of the trained neural network in a database for inference.

In another embodiment, a neural network pruning system is disclosed. The neural network pruning system includes a communication interface, a memory comprising executable instructions and a processor communicably coupled to the communication interface. The processor is configured to execute the executable instructions to cause the neural network pruning system to perform at least accessing a trained neural network to be pruned. The trained neural network includes one or more neural layers. The neural network pruning system is configured to compute values of layer parameters for a filter associated with a neural layer of the one or more neural layers based, at least in part, on a pruning criteria. The neural network pruning system is also configured to compute a tag identifier associated with the filter of the trained neural network based, at least in part, on corresponding values of layer parameters of the filter. The neural network pruning system is further configured to store the tag identifier and the values of the layer parameters for the filter of the trained neural network in a database for inference.

In yet another embodiment, a neural network pruning system is disclosed. The neural network pruning system includes a training engine, a pruning engine, a tag identifier generation engine and a database. The training engine is configured to generate a trained neural network comprising one or more neural layers. The pruning engine is configured to compute values of layer parameters of a filter associated with a neural layer of the one or more neural layers based, at least in part, on a pruning criteria. The tag identifier generation engine is configured to compute a tag identifier associated with the filter based, at least in part, on corresponding values of layer parameters of the filter. The database is configured to store the tag identifier and the values of the layer parameters for the filter of the trained neural network for inference.

Other aspects and example embodiments are provided in the drawings and the detailed description that follows BRIEF DESCRIPTION OF DRAWINGS

For a more complete understanding of example embodiments of the present technology, reference is now made to the following descriptions taken in connection with the accompanying drawings in which:

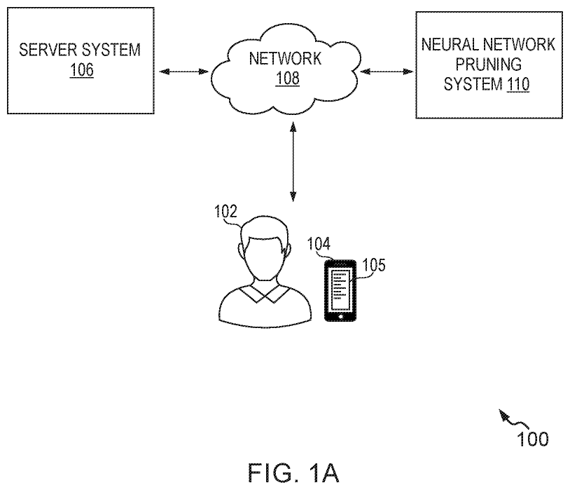

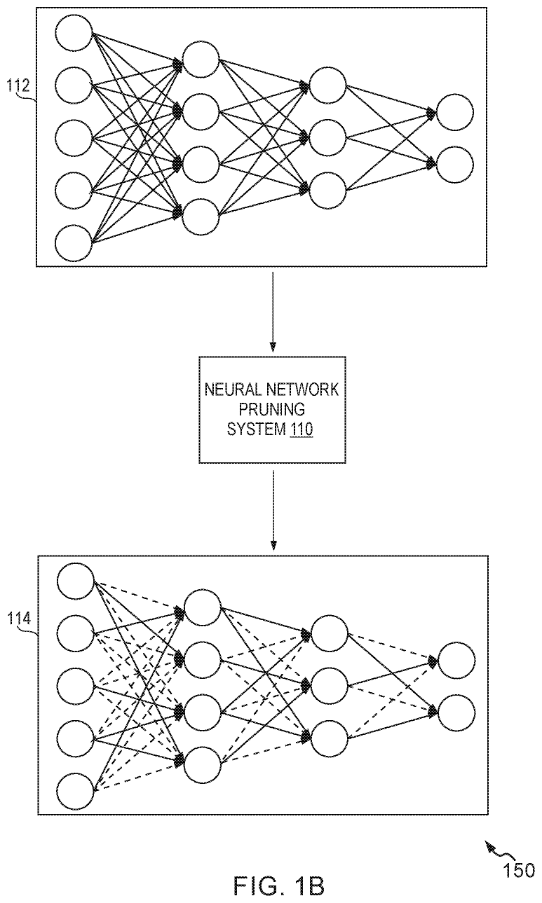

FIG. 1A and FIG. 1B, collectively, illustrate an example representation of an environment, in which at least some example embodiments of the present disclosure can be implemented;

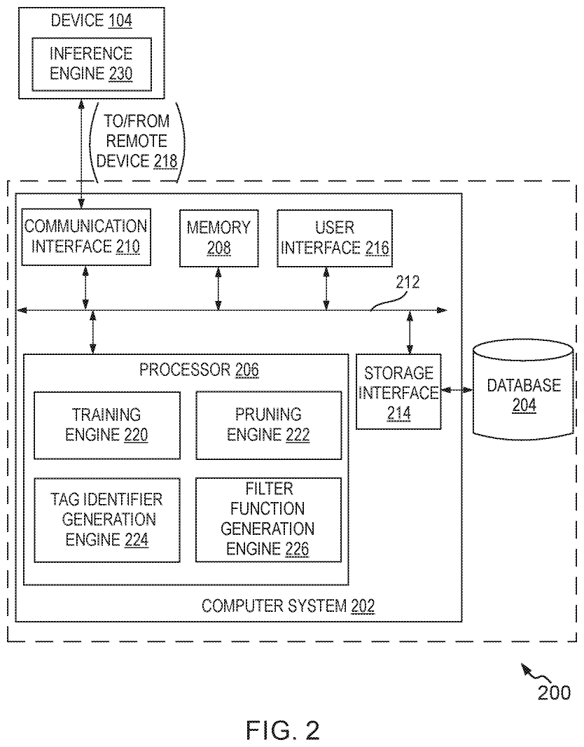

FIG. 2 illustrates a simplified block diagram of a neural network pruning system for unstructured pruning of a neural network, in accordance with an example embodiment;

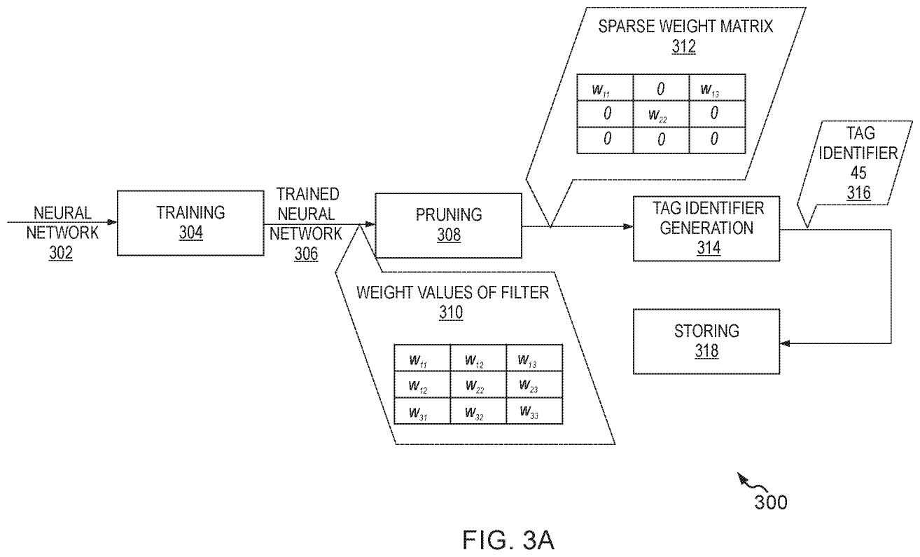

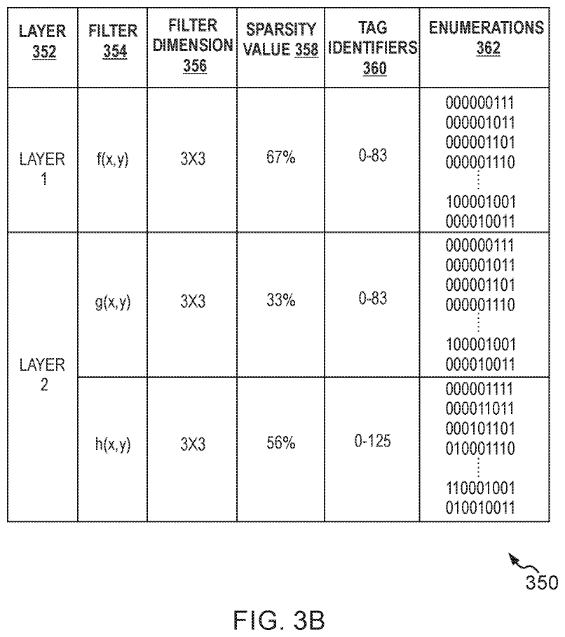

FIG. 3A illustrates a schematic block diagram representation for computing a tag identifier of a filter, in accordance with an example embodiment;

FIG. 3B illustrates an example representation of a table depicting a plurality of tag identifiers and corresponding enumerations for a filter of a trained neural network, in accordance with an example embodiment;

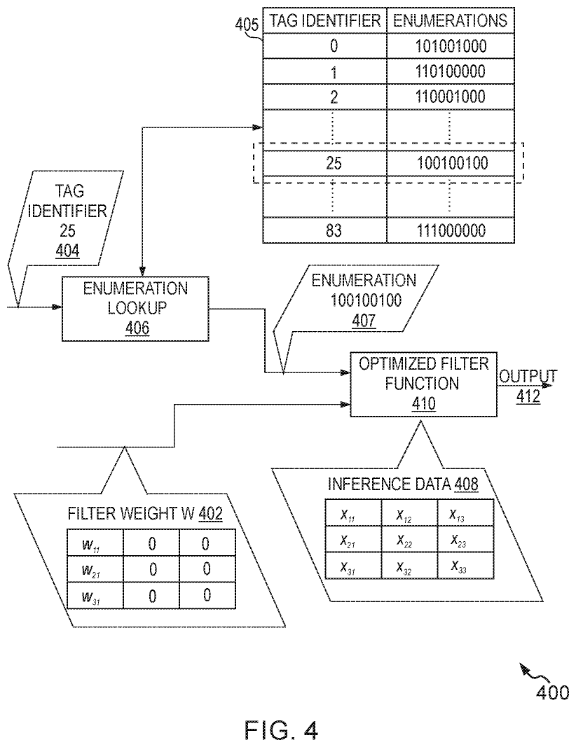

FIG. 4 illustrates an example representation of applying a filter to an inference data during an inference phase of a pruned neural network, in accordance with an example embodiment;

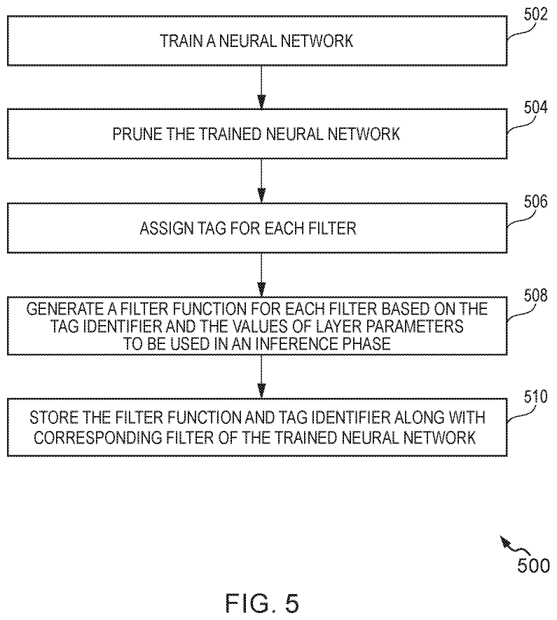

FIG. 5 represents a flow chart of a process flow for unstructured pruning of a neural network, in accordance with an example embodiment;

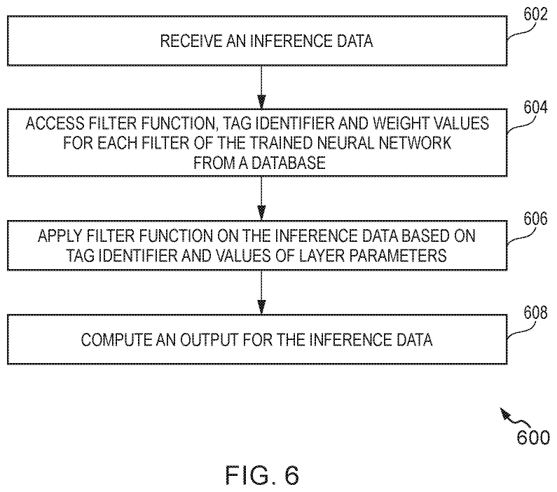

FIG. 6 represents a flow chart of a process flow of an inference phase using a pruned neural network, in accordance with an example embodiment;

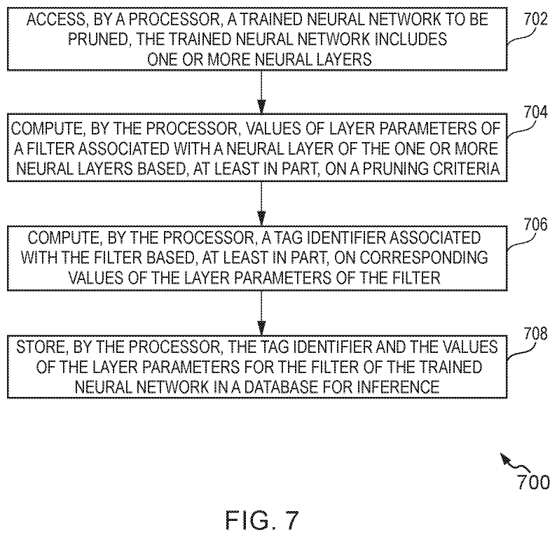

FIG. 7 represents a flow diagram of a method for unstructured pruning of a neural network, in accordance with an example embodiment; and

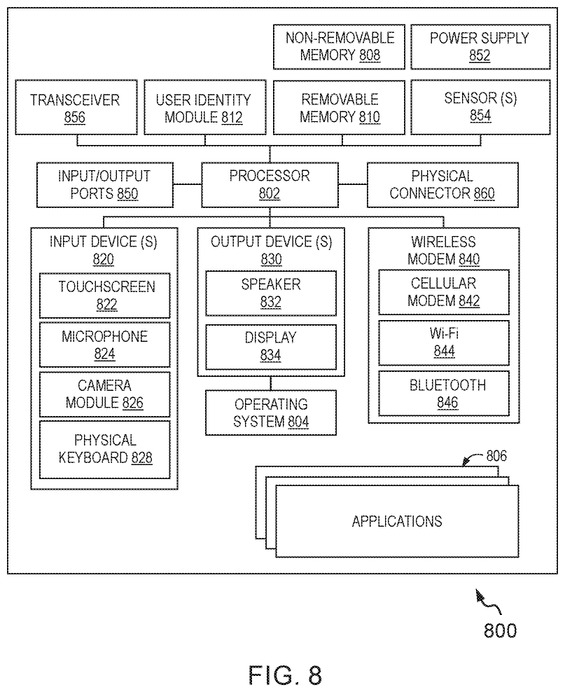

FIG. 8 shows simplified block diagram of an electronic device, for example, a mobile phone capable of implementing the various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term ‘pruning’ described herein, unless the context suggests otherwise, refers to the process of removing or masking or ignoring weight connections or setting weight values to ‘0’ in a network that are not important for increasing computational speed and decreasing storage space of a trained neural network without significantly affecting accuracy of the trained neural network.

Neural networks include a large number of nodes arranged in layers and each of the connections between the neurons of different layers is associated with a weight. Each neuron calculates the weighted input values from other neurons (i.e., neurons from other layers) using an activation function. During inference phase, the runtime of a neural network is dominated by the evaluation of hidden layers. In an example scenario, Convolutional Neural Networks (CNNs) include multiple convolutional layers utilizing convolutional filters that increase the computational complexity. For example, when a CNN is used for an application, such as, image processing, a matrix representation of a 3×3 filter (W) and a 3×3 window (X1) of an image data (X) is as shown below:

W=[▪(w_11&w_12&w_13@w_21&w_22&w_23@w_31&w_32&w_33)]

X_1=[▪(x_11&x_12&x_13@x_21&x_22&x_23@x_31&x_32&x_33)]

Assuming, the 3×3 filter (W) is applied on the 3×3 window (X1) of the image data (X), output (O) of this filter operation (i.e., convolution operation) can be mathematically expressed as shown below by equation 1.

O=W*X_1

O=w_11*x_11+w_12*x_12+w_13*x_13+w_21*x_21+w_22*x_22+w_23*x_23+w_31*x_31+w_32*x_32+w_33*x_33 (equation 1)

As shown by equation 1, a linear operation performed between the 3×3 filter (W) and the 3×3 window (X1) of the image data (X) requires 9 multiplication and 8 addition operations. Therefore, with an increase in number of layers and number of filters in each layers of deep neural networks, the computational complexity drastically increases resource requirements of GPUs.

Techniques suggest unstructured pruning of filters using binary masks with as many parameters as the neural network, such that the drop in performance of the neural network is minimal. The binary mask may be determined on the basis of pruning criteria. If the mask has an entry of ‘1’ at an index, the corresponding parameter (i.e., weight value) in the filter is ‘active’ and is used in the forward pass at inference. If the mask has an entry ‘0’, then the weight contribution is nullified on account of multiplying the weight value with the mask value. A binary mask (M) used for unstructured pruning of a 3×3 filter (W) is as shown below.

A=M*W

M=[▪(1&0&0@0&1&1 @0&0&1)]

W=[▪(w_11&w_12&w_13@w_21&w_22&w_23@w_31&w_32&w_33)]

A= [symbol] 1*w [symbol] _11+0*w_12+ [symbol] 0*q [symbol] _13+0*w_21+ [symbol] 1*w [symbol] _22+ [symbol] 1*w [symbol] _23+0*w_31+ [symbol] 0*w [symbol] _32+1*w_33 (equation 2)

As shown by equation 2, the technique of using a binary mask, or even setting the weights (i.e., filter coefficients) to 0 (i.e., instead of having a mask) will not reduce computational complexity of the neural network as a mathematical operation has to be performed between each element of the mask (M) and the filter (W).

Various embodiments of the present disclosure provide methods, systems electronic devices, and computer program products for unstructured pruning of a neural network. More specifically, embodiments of the present disclosure provide a method for exploiting the structure of a filter after pruning. Such techniques for unstructured pruning reduce computational complexity thereby providing computational and resource savings of hardware.

In an example, the present disclosure describes a neural network pruning system for unstructured pruning of a neural network. The neural network pruning system includes at least a processor and a memory. The neural network pruning system is configured to access a trained neural network to be pruned. In an embodiment, the trained neural network is a Convolutional Neural Network (CNN). A neural network is trained using any training algorithm known in the art to generate the trained neural network. The trained neural network includes one or more neural layers (i.e., hidden layers). Specifically, a number of layers depend on an application for which the trained neural network will be employed.

The neural network pruning system is configured to compute values of layer parameters for a filter associated with a neural layer of the one or more neural layers based, at least in part, on pruning criteria. In one embodiment, the filter is a convolution filter. In general, neural layers (i.e., hidden layers) of the neural network may be associated with one or more filters. The filters may have different filter dimensions and may be the same or different (i.e., same/different weight values) across one or more neural layers. In one embodiment, the layer parameter is a filter weight. In general terms, the pruning criteria define terms/rules to decide which weight values of a filter can be non-zero weight values to achieve an optimized neural network.

In one embodiment, the neural network pruning system is configured to prune the filter to obtain a sparse weight matrix including zero and non-zero elements based, at least in part, on the pruning criteria. The sparse weight matrix is an optimized weight matrix obtained after pruning the filter. During pruning, the neural network pruning system is configured to receive a sparsity value for the filter. More particularly, the sparsity value indicates a number of zero values of layer parameters in the filter. The sparsity value may be different for every filter in the trained neural network. In a non-limiting example, sensitivity analysis can be used to determine the sparsity value of the filter. Accordingly, the neural network pruning system is configured to adapt one or more values of the layer parameters (also interchangeably referred to as ‘weight values’) of the filter based, at least in part on, a corresponding sparsity value and the pruning criteria to generate the sparse weight matrix. For example, a threshold is decided based on the sparsity value and the pruning criteria. Weight values of the filter above the threshold are retained whereas weight values less than the threshold are set to ‘0’ in the filter in the sparse weight matrix. Alternatively, sensitivity analysis can be used to determine the sparsity value of a filter.

In some example embodiments, the neural network pruning system is configured to decompose the filters with higher-order filter dimensions using one or more filter decomposition techniques before pruning the trained neural network. Decomposing filters with the high order filter dimensions makes the neural network more amenable for pruning due to the simplified structure. Examples of filter decomposition techniques include, but are not limited to, matrix factorization, upper triangulation, lower triangulation, matrix regularization, and the like.

The neural network pruning system is configured to compute a tag identifier associated with the filter based, at least in part, on corresponding values of layer parameters of the filter. In other words, the tag identifier associated with the filter is determined based on the sparse weight matrix. The tag identifier indicates spatial locations of the non-zero elements (i.e., weight values) of the sparse weight matrix. More specifically, a structure of the filter (i.e., sparse weight matrix) is identified by the neural network pruning system after pruning. The structure defines the indices of non-zero values of layer parameters in the filter. Accordingly, the neural network pruning system is configured to determine an enumeration, based at least in part, on the structure of the filter. In other words, the neural network pruning system performs a lookup of enumerations in a table based on the identified structure of the filter. Enumerations refer to different combinations of non-zero weight values at various indices of the filter (i.e., 9 indices of a 3×3 filter). Accordingly, the table includes entries of possible enumerations for a given filter.

In some example embodiments, the neural network pruning system is configured to receive an enumeration preference for each of the plurality of filters. The enumeration preference is usually less than a total number of enumerations possible for a filter with a specific sparsity value. The enumeration preference is used to restrict possible enumerations in cases where filter dimensions are high to reduce implementation complexity. The neural network pruning system is configured to determine a subset of enumerations among the plurality of enumerations based, at least in part, on the enumeration preference and the pruning criteria. For example, the subset of enumerations includes enumerations that occur frequently in the plurality of filters with the same filter dimensions.

Further, the neural network pruning system is configured to assign the tag identifier for the filter, based at least in part, on the enumeration. In general, the tag identifier is an index that corresponds to the enumeration identifying the structure of the filter. More specifically, the tag identifier is indicative of weight elements of the filter that are to be multiplied with input data (i.e., inference data) of the filter. The tag identifiers are unique for each filter of the neural network, for example, two different enumerations cannot have the same tag identifier nor can one enumeration have two different tag identifiers.

The neural network pruning system is configured to store the tag identifier and the values of the layer parameters for each filter of the plurality of filters of the trained neural network in a database.

In an embodiment, the neural network pruning system is configured to generate a filter function for the filter associated with the neural layer of the trained neural network to be used in an inference phase. The filter function is based, at least in part, on the tag identifier, the values of the layer parameters of the filter, and an input variable. The input variable is a vector that takes a value corresponding to the input data (i.e., inference data). The filter function is a neural network operation based on an implementation of the filter. In one embodiment, the neural network operation is a convolution operation between the filter and the input data. More specifically, the filter function is an optimized implementation of the filter based on the tag identifier. The filter function is stored in the database.

During an inference phase, the neural network pruning system is configured to access the filter function, the values of the layer parameters, and a corresponding tag identifier for the filter of the trained neural network from the database. Thereafter, the filter function is applied on inference data at the neural layer of the trained neural network. In one embodiment, the filter function is a convolution function between the filter (i.e., the sparse weight matrix) and the test data based on the tag identifier to determine an output. This filter function is an optimized filter function that reduces the computational complexity due to fewer network parameters (i.e., weight values) thereby providing memory savings and improving the performance of the trained neural network due to a reduction in floating-point operations per second (FLOPS).

The neural network operations (i.e., filter function) of each filter corresponding to each tag identifier ensure that these operations make use of the sparsity in the filter and thus provide computational savings. For example, if there are ‘n’ tags in a convolutional neural network, then there will be ‘n’ convolutional operations corresponding to each tag that precludes multiplication and addition of zero weight values with the corresponding value of input data and thus providing significant saving on memory and computing.

Various embodiments of the present disclosure offer multiple advantages and technical effects. For instance, the present disclosure provides an unstructured pruning of a neural network to generate an optimized neural network for reducing the computational complexity.

FIG. 1A illustrates an exemplary representation of an environment 100 related to at least some example embodiments of the present disclosure. Although the environment 100 is presented in one arrangement, other embodiments may include the parts of the environment 100 (or other parts) arranged otherwise depending on, for example, pruning neural networks, etc. The environment 100 generally includes a user 102, a server system 106, and a neural network pruning system 110 each coupled to, and in communication with (and/or with access to) a network 108. The network 108 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among two or more of the parts or users illustrated in FIG. 1A, or any combination thereof. Various entities in the environment 100 may connect to the network 108 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof.

For example, the network 108 may include multiple different networks, such as a private network made accessible by a device 104 associated with the user 102, and a public network (e.g., the Internet) through which the user 102 and the server system 106 or the neural network pruning system 110 may communicate. In one embodiment, the user 102 may access the device 104 for installing one or more applications.

The server system 106 may include a web server, a client-server, open-source server, real-time communication server, proxy server, virtual server, or any combination thereof. In one example embodiment, the server system 106 is an application server and acts as a distribution platform for distributing applications to one or more users, for example, the user 102. The user 102 may be associated with one or more mobile devices, for example, the device 104. The device 104 may be any electronic device such as, but not limited to, a personal computer (PC), a tablet device, a Personal Digital Assistant (PDA), a voice-activated assistant, a Virtual Reality (VR) device, a smartphone, and a laptop.

The user 102 can access the server system 106 to download an instance of an application 105, for example, an image recognition application using a deep neural network on the device 104 via the network 108. The network 108 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among the entities illustrated in FIG. 1A, or any combination thereof.

The neural network pruning system 110 is configured to perform one or more of the operations described herein. In specific, the neural network pruning system 110 is configured to optimize the deep neural network (e.g., trained neural network 112) employed by the application 105. The optimized neural network (see, pruned neural network 114) reduces the resource requirements of the application 105 on the device 104 when the application 105 is in use. Moreover, the optimized neural network has fewer parameters, thereby efficient in computations and power consumption.

As shown by a schematic representation 150, the neural network pruning system 110 performs an unstructured pruning of the trained neural network 112 to provide a pruned neural network 114 (i.e., optimized neural network). Neurons are represented as circles in each layer and interconnections between the neurons of different layers are represented by arrows (i.e., solid arrows in the trained neural network 112) that are associated with weight values (not shown). In general, the neural network pruning system 110 removes/masks one or more interconnections (i.e., weight values) between neurons during unstructured pruning to efficiently use available resources. For example, connections corresponding to smaller weight values may be removed or ignored. The interconnections (i.e., weight values) that are ignored are represented by dotted lines in the pruned neural network 114. The pruned neural network 114 that may be used by the application 105 has reduced FLOPS thereby reducing computational complexity in the device 104. The neural network pruning system 110 is a separate part of the environment 100, and may operate apart from (but still in communication with, for example, via the network 108) the server system 106 and any third party external servers (to access data to perform the various operations described herein). However, in other embodiments, the neural network pruning system 110 may be incorporated, in whole or in part, into one or more parts of the environment 100, for example, the server system 106 or the device 104. In addition, the neural network pruning system 110 should be understood to be embodied in at least one computing device in communication with the network 108, which may be specifically configured, via executable instructions, to perform as described herein, and/or embodied in at least one non-transitory computer-readable media.

The number and arrangement of systems, devices, and/or networks shown in FIGS. 1A, 1B are provided as an example. There may be additional systems, devices, and/or networks; fewer systems, devices, and/or networks; different systems, devices, and/or networks; and/or differently arranged systems, devices, and/or networks than those shown in FIGS. 1A, 1B. Furthermore, two or more systems or devices shown in FIGS. 1A, 1B may be implemented within a single system or device, or a single system or device shown in FIGS. 1A, 1B may be implemented as multiple, distributed systems or devices. Additionally or alternatively, a set of systems (e.g., one or more systems) or a set of devices (e.g., one or more devices) of the environment 100 may perform one or more functions described as being performed by another set of systems or another set of devices of the environment 100.

Various embodiments of the neural network pruning system 110 are shown and explained with reference to FIGS. 2-8.

Referring now to FIG. 2, a simplified block diagram of a neural network pruning system 200 is shown, in accordance with an example embodiment. The neural network pruning system 200 is similar to the neural network pruning system 110. In some embodiments, the neural network pruning system 200 is embodied as a cloud-based and/or SaaS-based (software as a service) architecture. In one embodiment, the neural network pruning system 200 is a part of the server system 106 or integrated within the device 104.

The neural network pruning system 200 includes a computer system 202 and a database 204. The computer system 202 includes at least one processor 206 for executing instructions, a memory 208, a communication interface 210, a storage interface 214 and a user interface 216 that communicate with each other via a bus 212.

In some embodiments, the database 204 is integrated within the computer system 202. For example, the computer system 202 may include one or more hard disk drives as the database 204. A storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In some example embodiments, the database 204 is configured to store tag identifiers of filters associated with a trained neural network (i.e., pruned neural network).

Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the neural network pruning system 200, as described herein. In another embodiment, the memory 208 may be realized in the form of a database server or a cloud storage working in conjunction with the neural network pruning system 200, without departing from the scope of the present disclosure.

The processor 206 is operatively coupled to the communication interface 210 such that the processor 206 is capable of communicating with a remote device 218 such as, the server system 106, or communicating with any entity connected to the network 108 (as shown in FIG. 1A). In one embodiment, the remote device 218 is the user device 104 that is configured to perform inference using an optimized neural network after pruning. Further, the processor 206 is operatively coupled to the user interface 216 for receiving pruning criteria. More particularly, the user interface 216 may be used by a user (i.e., developer) for receiving sparsity values and/or enumeration preference for the filter of the trained neural network.

It is noted that the neural network pruning system 200 as illustrated and hereinafter described is merely illustrative of an apparatus that could benefit from embodiments of the present disclosure and, therefore, should not be taken to limit the scope of the present disclosure. It is noted that the neural network pruning system 200 may include fewer or more components than those depicted in FIG. 2.

In one embodiment, the processor 206 includes a training engine 220, a pruning engine 222, a tag identifier generation engine 224, and a filter function generation engine 226. It should be noted that components, described herein, can be configured in a variety of ways, including electronic circuitries, digital arithmetic and logic blocks, and memory systems in combination with software, firmware, and embedded technologies.

The training engine 220 includes suitable logic and/or interfaces for training a neural network. The training engine 220 is configured to apply machine learning algorithms over a training dataset to learn one or more features from the training dataset. In one embodiment, the machine learning algorithms may be, supervised and/or unsupervised techniques, such as those involving artificial neural networks, association rule learning, recurrent neural networks (RNN), Bayesian networks, clustering, deep learning, decision trees, genetic algorithms, Hidden Markov Modeling, inductive logic programming, learning automata, learning classifier systems, logistic regressions, linear classifiers, quadratic classifiers, reinforcement learning, representation learning, rule-based machine learning, similarity and metric learning, sparse dictionary learning, support vector machines, and/or the like.

In general, when a training dataset is provided to the neural network, the neural network learns to map each input data of the training dataset to an output data as the input data passes through one or more neural layers of the neural network. More particularly, some neural layers of the neural network are associated with a filter and a filter function is applied to the input data to determine the output data. In one embodiment, the filter is a convolutional filter that performs a convolution function of the input data and values of layer parameters (also interchangeably referred to as ‘weight values’) of a filter. After each iteration, errors are propagated back through the hidden layers into the neural network (e.g., backpropagation algorithm) and weight values of the filter in each layer are adapted to achieve accurate results for a specific problem. This training process is iterative and values of layer parameters are updated in small increments/decrements at each iteration which effects a change in the performance of the neural network in each iteration. More particularly, the training engine 220 finds weight values for each interconnection (i.e., filter) in the trained neural network that provide optimal results.

It shall be apparent that although the invention has been described with reference to a filter in a neural layer, practically the neural network includes one or more neural layers and each neural layer may include a plurality of filters with the same or different filter dimensions.

The pruning engine 222 includes suitable logic and/or interfaces for pruning the trained neural network based on pruning criteria. Pruning refers to the process of removing or masking connections in a filter that may not be important. In other words, pruning refers to a method of deciding weight values that will be ignored in each filter. In one non-limiting example, the pruning criteria may indicate that weight values of a filter that is less than a threshold be set to indicate ‘0’. For example, if f(x,y) is a 3×3 filter with 9 weight values, the weight values that are less than the threshold (e.g., Tf≤0.5) in the filter f(x,y) are set to ‘0’ and other weight values are retained as such.

In one embodiment, the pruning engine 222 is configured to prune the filter to obtain a sparse weight matrix. The sparse weight matrix includes zero and non-zero elements based on the pruning criteria. In some example embodiments, the pruning criteria may depend on a sparsity value. The sparsity value indicates the desired number of zero-valued elements (i.e., weight values that are zero) in the filter. Accordingly, one or more weight values of a filter may be adapted to assume a weight value of zero based on the sparsity value and the pruning criteria of a corresponding filter. For example, when a fixed level of sparsity (e.g., 67%) is desired in a filter, assuming a 3×3 filter (e.g., filter f(x,y)), the pruning engine 222 sets 6 weight values of the 9 weight values of the filter f(x,y) to ‘0’. In one non-limiting example, the absolute value of the 9 weight values in the 3×3 filter f(x,y) are sorted in descending order and the least 6 weight values are set to 0 to generate a sparse weight matrix of the filter f(x,y) as shown below.

f(x,y)=[▪(w_11&0&0@0&0&w_23@0&0&w_33)]

The pruning engine 222 can set 6 weight values of the 9 weight values of the filter f(x,y) to ‘0’ in 9C3 different ways (i.e., 84 combinations). In general, the indices of the non-zero weight values in the sparse weight matrix can assume 84 combinations of weight values in a filter based on the sparsity value and the filter dimension (i.e., 3×3 filter). These different ways or combinations that are possible for non-zero weight values (i.e., elements) are also interchangeably referred to as ‘enumerations’. The total number of enumerations depends on the sparsity value of the filter. For example, if a 56% sparsity value is fixed for a 3×3 filter, then there exist 4 non-zero weight values in the filter f(x,y) that can be arranged in 126 different ways (i.e., 126 enumerations) in the filter f(x,y). Alternatively, if the pruning criteria decide on 6 non-zero weight values in the 3×3 filter f(x,y), then it results in a sparsity of 33% and the 6 non-zero weight values can assume 84 enumerations.

It shall be apparent that every filter in the trained neural network may be configured to have different sparsity levels and accordingly weight values of each of the filter is set to zero based on the pruning criteria. For instance, when a variable level of sparsity is desired for a plurality of filters in the trained neural network, distribution of weight values from all filters in a neural layer (i.e., hidden layer) are analysed by the pruning engine 222 that computes the threshold based on the analysis. Thereafter, the weight values in each of the filters are compared with the threshold (Tf) and weight values less than the threshold (Tf) are set to zero. This results in different sparsity values for each filter as the number of weight values less than the threshold Tf (zero-valued elements) may vary in each filter.

Moreover, as the sparsity level (i.e., non-zero elements) in a filter decreases, the enumerations and corresponding implementations increase. Therefore, deciding the pruning criteria based on the sparsity level is usually a tradeoff between implementation complexity and the computational complexity (i.e., memory gain) achieved due to exploiting sparsity in the filter.

In some example embodiments, higher-order filter dimensions of filters in the trained neural network can be reduced to lower dimensions or simpler matrices by matrix decomposition techniques which are more amenable to unstructured pruning. For example, if 80% of sparsity is desired in a 5×5 filter, then there can be 5 non-zero weight values in the filter. Accordingly, there can be 25C5 (i.e., 53130) enumerations for the 5×5 filter with the sparsity level of 80%. Such enumerations become very cumbersome from an implementation point of view.

Examples of matrix decomposition include, but are not limited to, matrix factorization, matrix regularization, upper triangulation, lower triangulation techniques and the like.

In some example embodiments, the pruning engine 222 is configured to receive an enumeration preference for each filter in the trained neural network. The enumeration preference may be a number of enumerations (e.g., 1000 enumerations) that are less than the total number of enumerations (e.g., 53130) possible for the filter with specific sparsity. In one embodiment, the pruning engine 222 is configured to determine a subset of enumerations among a plurality of enumerations based, at least in part, on the enumeration preference and the pruning criteria. More particularly, the subset of enumerations can be selected for representing the structure of the filter after pruning the trained neural network. In other words, the total number of enumerations can be restricted by analyzing filter data (i.e., weight values). Specifically, if certain indices (i.e., weight values at specific indices) of the filter can be ignored for all computations, this drastically reduces the number of enumerations. In other words, assuming the same indices can be set to ‘0’ across all filters (e.g., 5×5 filters) and across all layers, the total number of indices will be less than 25.

In one non-limiting example, a CNN has ‘n’ filters of dimension 5×5 across all layers (e.g., 3 layers) and assuming n<<53130 (i.e., number of enumerations for sparsity value of 80%), it is highly unlikely that 53130 enumerations equally occur in the all filters across all the layers. In such cases, a histogram (i.e., distribution) is plotted for the CNN with enumeration (e.g., 53130 enumerations) on the x-axis and number of filters (e.g., 5 filters) which occur with the same enumeration on the y-axis. The distribution is analyzed and based on the desired number of enumerations, for example, frequently occurring enumerations alone are selected to form the subset of the enumeration. For example, if it is decided to retain/select only 1000 enumerations of the 53130 enumerations during pruning, the enumerations are sorted based on the frequency in filters and only 1000 enumerations that occur frequently are selected for the subset of the enumerations and the remaining enumerations are ignored. It shall be noted that the filters whose enumerations are ignored, can be left unpruned. However, this will come at the cost of sparsity but will provide better functional performance (i.e., accuracy).

In some example embodiments, if two different filters (e.g., a 5×5 filter and 3×3 filter) are used, unstructured pruning can only be applied on the 3×3 filter if pruning and implementation of the 5×5 filter cannot be managed. However, the sparsity value that can be achieved will be less when compared to a 5×5 filter that is pruned.

Although embodiments of the present disclosure describe the unstructured pruning of a CNN with reference to a convolutional filter, it shall be noted that the methods disclosed shall be adaptable to use with any type of deep neural network using a filter.

The tag identifier generation engine 224 includes suitable logic and/or interfaces for generating a tag identifier for each filter of the neural network after pruning. After pruning, the tag identifier generation engine 224 computes a tag identifier for the filter based on values of layer parameters (i.e., weight values) of the filter. In other words, the tag identifier of the filter is based on the sparse weight matrix. The tag identifier indicates the spatial locations of the non-zero elements of the sparse weight matrix. More particularly, the tag identifier generation engine 224 is configured to identify a structure of the filter (i.e., sparse weight matrix). The structure defines the indices of non-zero weight values in the filter. Accordingly, the tag identifier generation engine 224 determines an enumeration based on the structure of the filter. An index associated with the enumeration is assigned as the tag identifier for the filter. In other words, the tag identifier is generally an index that identifies a combination of filter values that are non-zero elements.

As already explained, if 67% sparsity is desired in the filter f(x,y) after pruning the trained neural network, the non-zero elements of the 3×3 filter f(x,y) can be arranged in 9C3 different ways (i.e., 84 combinations). Each enumeration is a combination of binary numbers (i.e., ‘0’ and ‘1’) that indicate where the 3 non-zero weight values can occur in a string of 9 elements for a 3×3 filter with 67% sparsity. For example, the 3×3 filter f(x,y) has 9 locations and a spatial arrangement of the non-zero elements of the filter f(x,y) can assume one of the following 84 different enumerations. The tag identifier indicating the enumeration is listed beside the enumeration as follows.
0—000000111
1—000001011
2—000001101
3—000001110
•
•
•
82—100001001
83—000010011.

In general, the tag identifier is a representation of an enumeration from the 84 enumerations that describes a structure or spatial arrangement of the filter f(x,y). In a non-limiting example, tag identifier for the filter f(x,y) shown above may be computed as ‘82’. In other words, the tag identifier ‘82’ indicates the location of non-zero elements (i.e., weight values) in the filter f(x,y) as 100001001. In other words, the tag identifier indicates that indices 0, 5, and 8 of the 3×3 filter f(x,y) have non-zero elements. More specifically, the tag identifier is indicative of weight elements of the filter (i.e, weight values of the filter) that are to be multiplied with an input data of the filter. In one embodiment, the tag identifier and the values of the layer parameters (i.e., weight values) for each filter of the trained neural network are stored in the database 204.

However, it shall be apparent that a tag identifier is unique for each filter and the same tag identifier cannot be used to represent two different combinations or two different tag identifiers shall not identify one enumeration. It shall be apparent that the tag identifier can be represented in any manner as long as the representation is unique and consistent among all filters of the trained neural network.

The filter function generation engine 226 includes suitable logic and/or interfaces for generating a filter function for the filter associated with the neural layer of the trained neural network to be used in an inference phase. The filter function is based, at least in part, on the tag identifier, the values of the layer parameters of the filter, and an input variable. The input variable is a vector that takes a value corresponding to the input data (i.e., inference data).

The filter function is a neural network operation based on an implementation of the filter (e.g., filter f1). More specifically, the filter function is an optimized implementation (i.e., optimized filter function) of the filter based on the tag identifier. For example, a neural layer may use filter f1. Accordingly, a tag identifier t1 associated with filter f1 of the neural layer is used to define the filter function. In at least one example embodiment, the filter function is a convolution operation performed by a convolution filter of the CNN. Assuming, a 3×3 window of input data d1 the filter function is represented by equation 3 as shown below:

Filter function h(x)=h(f1,d1)=f1(t1)*d1 equation 3

As shown by equation 3, the filter f1 depends on tag identifier t1. More particularly, the tag identifier t1 ¬indicates indices of weight values in the filter f1 that are non-zero elements. In other words, weight values of the filter f1 that is to be convolved with the input data d1 are represented by the tag identifier. For example, the 3×3 filter f1, the tag identifier t1 and a generic representation of a 3×3 window of the input data to which the filter f1 is applied and the filter function h(x) are as shown below:

t_1=23f_1=[▪(0&w_12&0@0&0&w_23@0&0&w_33)]

d_1=[▪(d_11&d_12&d_13@d_21&d_22&d_23@d_31&d_32&d_33)]

h(f_1,d_1)=w_12*d_12+w_23*d_23+w_(33)*d_23 equation 4

As shown by equation 4, the filter function is configured to perform a neural network operation (i.e., convolution) based on the optimized implementation of the filter function h(f1, d1) (i.e., convolution function f1 (t1)*d1) dependent on the tag identifier. The optimized implementation of the filter function provides computation savings by not performing operations (i.e., convolution operation) with pruned filter weights (i.e., weight values w_11, w_13, w_21, w_22, w_31, w_32) that have no bearing on a final output (i.e., output of the convolution operation). In this example scenario, only 3 weight values and corresponding tag identifier of the filter f1 alone are stored instead of 9 weight values of the filter f1, thereby providing memory savings due to less storage. The tag identifier provides the spatial information (i.e., location) of the 3 weight values in the 3×3 filter f1. Therefore, during inference only 3 multiplication and 2 addition operations are performed to determine the output of the filter f1, therefore providing significant computation savings, which leads to power savings and better latencies.

It shall be noted that the input data d1 (i.e., d_11, d_12, d_13, d_21, d_22, d_23, d_31, d_32, d_33) is an input variable and assumes different values based on an inference data provided during an inference phase. The filter function for the filter is stored in the database along with the tag identifier and the weight values of the filter.

During inference, a remote device (e.g., the device 104) equipped with an inference engine 230 can employ the pruned neural network (i.e., optimized neural network) for inference. In general, the inference engine 230 applies the knowledge acquired by the pruned neural network to determine output for inference data. More specifically, the inference engine 230 accesses the optimized filter function, the tag identifier, and the weight values of the filter associated with the neural layer of the trained neural network from the database 204. For example, a first neural layer may use the filter f1 and a second neural layer may use the filters f2, f3. Accordingly, tag identifier t1 associated with filter f1 of the first neural layer and tag identifiers t2, t3 associated with the filters f2, f3, respectively are accessed from the database 204.

In an embodiment, the filter function is applied on the inference data at each neural layer (i.e., first and second neural layer) of the trained neural network to compute the output for the inference data. The output (O1) of the first neural layer is computed based on the filter function shown in equation 3.

The filter function is based on the tag identifier (e.g., 23). The tag identifier t1 shown as a numerical index ‘23’ is representative of an enumeration from a plurality of enumerations possible for the sparsity level and indicates the location of the non-zero elements as “010001001”. In other words, the numerical index (i.e., tag identifier) is indicative of weight elements (i.e., weight values) of the filter that are to be multiplied with an input data of the filter among a plurality of enumerations which is defined based on the sparsity level. Accordingly, the inference engine 230 is configured to read weight values from indices 1, 5, and 8 of the filter h(x) (i.e., w_12, w_23, w_33) and input data from corresponding indices 1, 5, 8, respectively (i.e., d_12, d_23, d_33) based on the optimized filter function shown in equation 4 to determine the output O1.

As shown by equation 4, the output at the first neural layer (O1) is computed by means of 3 multiplication operations and 2 addition operations between the filter f1 and the 3×3 window of the inference data d1 when compared with 9 multiplication operations and 8 addition operations (see, equation 1) that would be performed if the trained neural network was not pruned or if it employed a mask (as shown by equation 2). The tag identifier indicates which 3 elements in the inference data d1 are to be multiplied with the weight values of the filter f1. More specifically, the tag identifier ¬indicates indices of weight values in the filter f1 that are non-zero elements and are to be multiplied with corresponding indices of elements in the test data d1. Accordingly, the use of a tag identifier results in computational savings by significantly reducing the FLOPS. The reduction of FLOPS reduces computational complexity and provides considerable savings of storage space.

In a similar manner, each filter (e.g., filters f2, f3) is applied to the inference data d1 at respective layers and the output O of the optimized neural network for the inference data d1 is determined based on the filter function performed at the different layers of the optimized neural network.

In an example scenario, if the trained neural network has 4 hidden layers L1, L2, L3, L4 with 16, 32, 64, and 128 filters of size 3×3, respectively then the trained neural network employs 240 filters across all layers L1, L2, L3, L4. It shall be noted that the 240 filters have not been pruned. Accordingly, one convolution operation of each filter with a 3×3 input data would result in 240 (filters)×9 (elements)=2160 MACs. Alternatively, pruning of the trained neural network and computing tag identifiers for each of the 240 filters assuming a 67% sparsity (i.e., pruning criteria) would result in 240 (filters)×3 (elements)=720 MACs which is a 67% saving in computations.

FIG. 3A illustrates a schematic block diagram representation 300 of a process flow for computing a tag identifier, in accordance with an example embodiment.

At first, the processor 206 is configured to train a neural network (see, 302) such as, a CNN using a training dataset to generate a trained neural network (see, 306). The training unit 304 may use any training method, for example, stochastic gradient descent algorithms, known in the art for training the neural network. Although the trained neural network (see, 306) provides an accurate output (i.e., prediction, classification, etc.), the resource requirements of the trained neural network are huge.

During pruning, the pruning unit 308 is configured to reduce the resource requirements of the trained neural network by reducing the computational complexity of the trained neural network. The computational complexity is reduced by pruning the trained neural network. More particularly, the weight values of a filter (see, Table 310) that provide accurate results are pruned based on pruning criteria to generate a sparse weight matrix so that there is no significant change in the performance of the trained neural network. In other words, values of layer parameters (i.e., weight values) on interconnections between neurons of different layers are masked or removed to reduce the computational complexity (see, Table 312). The spatial structure of the filter (i.e., sparse weight matrix) that includes a number of zero weight values (see, Table 312) reduces the number of Multiply-Add/Accumulate (MAC) operations of the trained neural network 306.

In an embodiment, the tag identifier generation unit 314 is configured to assign a tag identifier (see, 316) that identifies an enumeration of a plurality of enumerations possible for layer parameters of a filter. More specifically, the tag identifier identifies indices of weight values in a filter that are to be convolved with corresponding indices of elements in a test data. Such identification by the tag identifier drastically reduces the number of FLOPs in the optimized neural network. An example of the convolution operation between a filter of a pruned neural network and a window of a test data is shown by equation 4. The tag identifier is stored along with a corresponding filter in a database for use in an inference phase when the filter is applied on test data (see, 318). The inference engine 230 of the device 104 identifies spatial locations of the non-zero weight values of the filter (see, 312) based on the tag identifier even though all the weight values of the filter (see, 310) are not stored.

Referring now to FIG. 3B, an example representation of a table 350 maintained at a database depicting tag identifiers along with corresponding filters of an optimized neural network is represented in accordance with an example embodiment.

The table 350 includes a plurality of data field columns such as, but not limited to, layer ID 352, filter type 354, filter dimension 356, sparsity value 358, tag identifier 360, and corresponding enumeration 362. The layer ID 352 indicates a hidden layer of a number of hidden layers in a trained neural network. The type of filter is defined under filter type 354 that may also represent values of layer parameters (not shown in FIG. 3B) of each of the filter (e.g., filters f(x, y), g (x,y)). The dimensions of a filter (e.g., 3×3, 5×5) are defined under filter dimension 356 and indicate the total number of elements in each filter. The sparsity value 358 defines the pruning criteria for the filters in the trained neural network. Each filter can have ‘n’ number of enumerations (shown by column 362) based on the sparsity value, for example, the sparsity level of 33% for a 3×3 filter can have 84 enumerations. The 84 enumerations (i.e., combinations) are represented by tag identifiers (shown by column 360).

As an example, a first row depicts a first layer “Layer 1” that applies a filter “f(x, y)” of dimensions “3×3” that has been pruned based on a sparsity value 67%. Accordingly, the filter “f(x, y)” can have 3 non-zero weight values that can be arranged in 84 different ways in the “3×3” filter. The 84 different ways in which the non-zero weight values are located in the “3×3” filter “f(x, y)” are identified by the tag identifier indexed between “0-83”.

During an inference phase, to find out the correct indices or location of non-zero weight values, the processor 206 performs a look-up for an enumeration corresponding to the tag identifier and retrieves corresponding weight values from the filter to perform convolution function with corresponding elements in an inference data. The table 350 includes as many entries as the number of layers in the trained neural network.

Referring now to FIG. 4, an example representation 400 of applying a filter 402 to an inference data 408 during an inference phase using a pruned neural network (e.g., CNN) is illustrated in accordance with an example embodiment. The filter 402 is a 3×3 filter that was pruned based on a pruning criteria (e.g., sparsity level) to generate an optimized filter 402. Accordingly, the optimized filter 402 (i.e., represented by a sparse weight matrix) is provided a tag identifier 404 and stored in the database 204. It shall be noted that the optimized filter 402 is a sparse filter.

During the inference phase, when the optimized neural network receives the inference data D 408, the inference data D 408 is passed through one or more hidden layers (i.e., neural layers) of the optimized neural network. In an example, a hidden layer may be associated with a filter (e.g., the filter 402). Assuming, the filter 402 is associated with a first hidden layer, the processor 206 accesses the filter 402 and a tag identifier 404 corresponding to the filter 402. It shall be noted that the tag identifier 404 described is for example purposes only and the tag identifier may 404 be represented in a variety of ways than those mentioned above.

The tag identifier 404 (e.g., 25) identifies an enumeration 407 (i.e., 100100100) that describes a structure of the filter 402. In other words, the processor 206 performs an enumeration lookup 406 on the table 405 to identify a combination of indices (i.e., enumeration 407) that defines location of non-zero elements in the filter 402 based on the tag identifier 404. The possible enumerations for a 3×3 filters with 67% sparsity (i.e., 3 non-zero elements) and corresponding tag identifiers are shown in the table 405. As shown in FIG. 4, the tag identifier 404 represents an enumeration “100100100” that indicates non-zero elements of the filter at indices 0, 3, and 6. Such representation of non-zero elements of the filter 402 by the tag identifier 404 results in computational savings as only the non-zero elements of the filter 402 are considered when the filter 402 is applied on the inference data 408. It shall be noted that the tag identifier 404 described is for example purposes only and the tag identifier may 404 be represented in a variety of ways than those mentioned above.

In another embodiment, the tag identifier 404 can be generated such that the spatial information of the filter 402 is embedded in the tag identifier 404. For example, the spatial location of the three non-zero weight values in the filter 402 at indices 0, 3, 6 can be represented as (0,0), (1,0) and (2,0). In such cases, the enumeration lookup 406 can be avoided.

In an example embodiment, an optimized filter function 410 is performed when the filter 402 is applied on the inference data 408. In other words, the filter 402 is a convolutional filter. More particularly, the optimized filter function 410 is based on the tag identifier 404 that identifies the non-zero weight values of the filter 402 that are to be convolved with the inference data 408.

As an example, the tag identifier 404 represents an enumeration “100100100” indicating weight values w11, w21, w31 as non-zero elements that are to be convolved with corresponding elements in the inference data 408 (i.e., x11, x21, x31). Accordingly, the convolution function will provide an output P (see, output 412), where P=W*D or P=w_11*x_11+w_21*x_21+w_(31)*d_31. It shall be noted that the inference data 408 may be of higher dimensions and may include more than one window than shown in FIG. 4, however, only a 3×3 window of the inference data D is depicted in this example for the sake of brevity.

It must be apparent that the introduction of the tag identifier 404 reduces MAC during the inference phase that provides resource savings, computational and memory savings. Moreover, it shall be noted that the example representation 400 of applying the filter 402 of the optimized neural network in FIG. 4 is exemplary and only provided for the purposes of explanation. In practical scenarios, the optimized neural network may employ more number of filters and/or a variety of filters with different dimensions than that depicted in FIG. 4.

Referring now to FIG. 5, a flow chart 500 of a process flow for unstructured pruning of a neural network is illustrated in accordance with an example embodiment. The sequence of operations of the flow chart 500 may not be necessarily executed in the same order as they are presented. Further, one or more operations may be grouped together and performed in form of a single step, or one operation may have several sub-steps that may be performed in parallel or in a sequential manner.

At 502, a neural network is trained using a training dataset. In one embodiment, the neural network is a CNN that learns to map input training data to an output using one or more convolutional filters. The neural network may be trained using any supervised or unsupervised learning techniques known in the art.

At 504, the trained neural network is pruned based on pruning criteria to generate a pruned neural network (i.e., optimized neural network). In one example embodiment, a sparsity level is used for optimizing the neural network. For example, if a sparsity value of 56% is desired in a 3×3 filter, then there are 4 non-zero weight values in the 3×3 filter and the remaining weight values are either masked or set to 0.

At 506, a tag identifier is assigned for each filter of the pruned neural network. The tag identifier is a numerical index that corresponds to an enumeration. The enumeration identifies the location of the non-zero elements (i.e., non-zero weight values) in the filter. For example, the 4 non-zero weight values in the 3×3 filter can be arranged in 126 different ways. In other words, 126 representations are possible for different locations of the 4 non-zero values in the filter. The tag identifier identifies one combination/representation of the 126 different representations as a structure of the filter. An example of the tag identifier defining the structure of the filter is shown and explained with reference to FIG. 4.

At 508, a filter function is generated for each filter based on the tag identifier and the values of layer parameters to be used in an inference phase. The filter function is an optimized neural network implementation that defines weight elements of the filter that are to be multiplied with an input data of the filter.

At 510, the filter function, and the tag identifier are stored along with the corresponding filter of the trained neural network in a database. The tag identifier is a decisive factor in the inference phase and indicates 4 elements in an input window (e.g., 3×3 window) that are to be multiplied with corresponding weights in the filter. For example, each representation of the 126 representations identifies which elements of an input window (i.e., 3×3 window of test data) are to be multiplied with the 4 non-zero weight values.

FIG. 6 represents a flow chart 600 of a process flow of an inference phase using a pruned neural network, in accordance with an example embodiment. The operations depicted in the flow chart 600 may be executed by a user device, for example, the device 104 is shown and explained with reference to FIG. 1A.

At 602, an inference data is received. At 604, the filter function, the tag identifier, and weight values associated with each filter of the trained neural network are accessed from a database.

At 606, the filter function is applied to the inference data based on the tag identifier and the values of layer parameters. The tag identifier is indicative of weight elements of the filter that are to be multiplied with an input data (i.e., inference data) of the filter. In one embodiment, the filter function is a convolution operation. Accordingly, a convolution operation is performed between the inference data and each filter based on a corresponding tag identifier. The convolution functions refer to MAC operations that are performed between the weight values of the filter and elements of a window of the inference data. More particularly, the convolution function depends on the tag identifier. As already explained, the tag identifier identifies which elements from a window of test data (e.g., 3×3 window) are to be multiplied with the 4 non-zero weight values of the filter. Specifically, MAC operations are performed between the 4 non-zero elements and corresponding elements in the 3×3 window of inference data to determine output of the filter. An example of the convolution operation is shown and explained with reference to FIG. 4.

At 608, an output is computed for the inference data based on the convolution function. In other words, convolution operation between the filter and the inference data based on the tag identifier provides the output of the filter.

The sequence of operations of the method 600 need not be necessarily executed in the same order as they are presented. Further, one or more operations may be grouped together and performed in form of a single step, or one operation may have several sub-steps that may be performed in parallel or in a sequential manner.

Referring now to FIG. 7, a flow diagram of a method 700 for unstructured pruning of a neural network is illustrated in accordance with an example embodiment. The method 700 depicted in the flow diagram may be executed by, at least one server, for example, the server system 106 or the neural network pruning system 200 explained with reference to FIG. 2. Operations of the flow diagram of method 700, and combinations of operation in the flow diagram, may be implemented by, for example, hardware, firmware, a processor, circuitry and/or a different device associated with the execution of software that includes one or more computer program instructions. It is noted that the operations of the method 700 can be described and/or practiced by using a system other than the neural network pruning system 200. The method 700 starts at operation 702.

At operation 702, the method 700 includes accessing, by a processor, a trained neural network to be pruned. The trained neural network includes one or more neural layers. In one embodiment, the trained neural network is a CNN that has a number of hidden layers.

At operation 704, the method 700 includes computing, by the processor, values of layer parameters of a filter associated with a neural layer of the one or more neural layers based, at least in part, on pruning criteria. In one embodiment, the layer parameters are weights of the filter (i.e., weight values of the filter). The pruning criteria decides which of the weight values of the filter can be set to zero. Accordingly, the filter is pruned to obtain a sparse weight matrix comprising zero and non-zero elements based on the pruning criteria. In one example, a sparsity value is used as the pruning criteria. The sparsity value of the filter indicates a number of zero weight values in the filter. For example, when a sparsity value of 33% is desired in a 3×3 filter, then there are 6 non-zero weight values in the 3×3 filter and remaining weight values (i.e., 3 weight values) are set to ‘0’. Accordingly, one or more values of the layer parameters of the filter are adapted based on the sparsity value and the pruning criteria to generate the sparse weight matrix. In one non-limiting example, a threshold is selected based on the pruning criteria (i.e., sparsity value) to set 3 weight values of the 9 weight values in the 3×3 filter to ‘0’. Additionally or optionally, techniques such as matrix decomposition, for example, matrix factorization, upper triangulation, lower triangulation may be used to prune the trained neural network. Each layer of the one or more layers is associated with at least one filter of the plurality of filters. For example, if the trained neural network has two hidden layers L1, L2, the layer L1 may employ a filter f(x,y) to detect a feature (e.g., foreground objects) and the layer L2 may employ the filters f(x, y), g(x,y) to detect a different feature (e.g., background objects).

At operation 706, the method 700 includes computing, by the processor, a tag identifier associated with the filter based, at least in part, on corresponding values of the layer parameters of the filter. More particularly, a structure associated with the sparse weight matrix after pruning the filter is identified. The structure indicates spatial location of non-zero weight values of the filter in the sparse weight matrix. Accordingly, an enumeration from a plurality of enumerations is determined based on the structure of the sparse weight matrix of the filter or the values of the layer parameters. Thereafter, a tag identifier is selected from among a plurality of tag identifiers based on the enumeration. In other words, the tag identifier is an index value that is indicative of weight elements of the filter that are to be multiplied with an input data of the filter. An example of computing the tag identifier is shown and explained with reference to FIG. 4.

At operation 708, the method 700 includes storing, by the processor, the tag identifier and the values of the layer parameters for the filter of the trained neural network in a database for inference.

The sequence of operations of the method 700 need not be necessarily executed in the same order as they are presented. Further, one or more operations may be grouped together and performed in form of a single step, or one operation may have several sub-steps that may be performed in parallel or in a sequential manner.

FIG. 8 shows a simplified block diagram of an electronic device 800, for example, a mobile phone capable of implementing the various embodiments of the present disclosure. For example, the electronic device 800 may correspond to the device 104 associated with the user 102 who downloads and installs applications employing neural networks. The electronic device 800 is depicted to include one or more applications 806. The applications 806 can be an instance of an application downloaded from a third-party server such as, the server system 106.

It should be understood that the electronic device 800 as illustrated and hereinafter described is merely illustrative of one type of device and should not be taken to limit the scope of the embodiments. As such, it should be appreciated that at least some of the components described below in connection with the electronic device 800 may be optional and thus in an example embodiment may include more, less or different components than those described in connection with the example embodiment of the FIG. 8. As such, among other examples, the electronic device 800 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 800 includes a controller or a processor 802 (e.g., a signal processor, microprocessor, ASIC, or other control and processing logic circuitry) for performing such tasks as signal coding, data processing, image processing, input/output processing, power control, and/or other functions. An operating system 804 controls the allocation and usage of the components of the electronic device 800. In addition, the applications 806 may include common server performance monitoring applications or any other computing application.

The illustrated electronic device 800 includes one or more memory components, for example, a non-removable memory 808 and/or removable memory 810. The non-removable memory 808 and/or the removable memory 810 may be collectively known as a database in an embodiment. The non-removable memory 808 can include RAM, ROM, flash memory, a hard disk, or other well-known memory storage technologies. The removable memory 810 can include flash memory, smart cards, or a Subscriber Identity Module (SIM). The memory components can be used for storing data and/or code for running the operating system 804 and the applications 806. The electronic device 800 may further include a user identity module (UIM) 812. The UIM 812 may be a memory device having a processor built in. The UIM 812 may include, for example, a subscriber identity module (SIM), a universal integrated circuit card (UICC), a universal subscriber identity module (USIM), a removable user identity module (R-UIM), or any other smart card. The UIM 812 typically stores information elements related to a mobile subscriber. The UIM 812 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 800 can support one or more input devices 820 and one or more output devices 830. Examples of the input devices 820 may include, but are not limited to, a touch screen/a display screen 822 (e.g., capable of capturing finger tap inputs, finger gesture inputs, multi-finger tap inputs, multi-finger gesture inputs, or keystroke inputs from a virtual keyboard or keypad), a microphone 824 (e.g., capable of capturing voice input), a camera module 826 (e.g., capable of capturing still picture images and/or video images) and a physical keyboard 828. Examples of the output devices 830 may include, but are not limited to a speaker 832 and a display 834. Other possible output devices can include piezoelectric or other haptic output devices. Some devices can serve more than one input/output function. For example, the touch screen 822 and the display 834 can be combined into a single input/output device.

A wireless modem 840 can be coupled to one or more antennas (not shown in the FIG. 8) and can support two-way communications between the processor 802 and external devices, as is well understood in the art. The wireless modem 840 is shown generically and can include, for example, a cellular modem 842 for communicating at long range with the mobile communication network, a Wi-Fi compatible modem 844 for communicating at short range with an external Bluetooth-equipped device or a local wireless data network or router, and/or a Bluetooth-compatible modem 846. The wireless modem 840 is typically configured for communication with one or more cellular networks, such as a GSM network for data and voice communications within a single cellular network, between cellular networks, or between the electronic device 800 and a public switched telephone network (PSTN).

The electronic device 800 can further include one or more input/output ports 850, a power supply 852, one or more sensors 854, for example, an accelerometer, a gyroscope, a compass, or an infrared proximity sensor for detecting the orientation or motion of the electronic device 800 and biometric sensors for scanning biometric identity of an authorized user, a transceiver 856 (for wirelessly transmitting analog or digital signals) and/or a physical connector 860, which can be a USB port, IEEE 1294 (FireWire) port, and/or RS-232 port. The illustrated components are not required or all-inclusive, as any of the components shown can be deleted and other components can be added.

Without in any way limiting the scope, interpretation, or application of the claims appearing below, a technical effect of one or more of the example embodiments disclosed herein is to provide an optimized neural network that reduces computational complexity of a trained neural network. Various embodiments provide methods and systems for unstructured pruning of the neural network and thereby providing computational and memory savings by reducing FLOPS. The computational complexity is drastically decreased as unstructured pruning does not include operations of setting weight values to zero or employment of masks to mask specific weight values. Moreover, the use of a tag identifier identifies only non-zero elements of the filter for performing convolution operations that reduces a number of MACs.

The disclosed methods with reference to FIG. 7, or one or more operations of the neural network pruning system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc. described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the neural network pruning system 200 and its various components such as the computer system and the database may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method (700) for unstructured pruning of a neural network, the computer-implemented method (700) comprising:
accessing (702), by a processor (206), a trained neural network (112) to be pruned, the trained neural network (112) comprising one or more neural layers;
computing (704), by the processor (206), values of layer parameters of a filter associated with a neural layer of the one or more neural layers based, at least in part, on a pruning criteria;
characterized in that, the computer-implemented method (700) comprising:
determining, by the processor (206), an enumeration among a plurality of enumerations based, at least in part, on the values of the layer parameters of the filter, wherein the plurality of enumerations is defined based on a sparsity value of the filter;
computing (706), by the processor (206), a tag identifier (316) associated with the filter based, at least in part, on the enumeration, the tag identifier (316) having a single numerical value indicating spatial locations of non-zero layer parameters in the filter; and
storing (708), by the processor (206), the tag identifier (316) and the non-zero layer parameters for the filter of the trained neural network (112) in a database (204) for inference.

2. The computer-implemented method (700) as claimed in claim 1, wherein the layer parameters are weights of the filter.

3. The computer-implemented method (700) as claimed in claim 1, wherein the trained neural network (112) is a convolutional neural network, and wherein the filter is a convolutional filter.

4. The computer-implemented method (700) as claimed in claim 1, wherein computing the tag identifier (316) associated with the filter comprises:
pruning, by the processor (206), the filter to obtain a sparse weight matrix comprising zero and non-zero elements based, at least in part, on the pruning criteria; and
determining, by the processor (206), the tag identifier (316) associated with the filter based on the sparse weight matrix, the tag identifier (316) indicating spatial locations of the non-zero elements of the sparse weight matrix.

5. The computer-implemented method (700) as claimed in claim 4, wherein computing the values of the layer parameters for the filter comprises:
receiving, by the processor (206), the sparsity value for the filter, wherein the sparsity value indicates a number of zero values of the layer parameters in the filter; and
adapting, by the processor (206), one or more values of the layer parameters of the filter based, at least in part on, a corresponding sparsity value and the pruning criteria to generate the sparse weight matrix.

6. The computer-implemented method (700) as claimed in claim 4, wherein computing the tag identifier (316) further comprises:
identifying, by the processor (206), a structure associated with the sparse weight matrix after pruning;
determining, by the processor (206), the enumeration, based at least in part, on the identified structure; and
assigning, by the processor (206), the tag identifier (316) for the filter, based at least in part, on the enumeration, wherein the tag identifier (316) is indicative of weight elements of the filter that are to be multiplied with an input data of the filter.

7. The computer-implemented method (700) as claimed in claim 4, wherein computing the tag identifier (316) further comprises:
receiving, by the processor (206), an enumeration preference for the filter; and
determining, by the processor (206), a subset of enumerations among a plurality of enumerations based, at least in part, on the enumeration preference and the pruning criteria for the filter.

8. The computer-implemented method (700) as claimed in claim 1, wherein computing values of the layer parameters for the filter further comprises using one or more filter decomposition techniques on the filter with higher order filter dimensions to prune the trained neural network (112).

9. The computer-implemented method (700) as claimed in claim 1, further comprising:
generating, by the processor (206), a filter function for the filter associated with the neural layer of the trained neural network (112) to be used in an inference phase, wherein the filter function is based, at least in part, on the tag identifier (316), the values of the layer parameters of the filter and an input variable; and
storing, by the processor (206), the filter function for the filter in the database (204).

10. The computer-implemented method (700) as claimed in claim 9, wherein the tag identifier (316), the values of the layer parameters and the filter function associated with the filter of the neural layer are used to perform the inference on an inference data.
